(19) United States
(12) Patent Application Publication
(10) Pub. No.: US 2026/0292099 A1
(43) Pub. Date: Sep. 24, 2026

(54) PERIPHERAL DISPLAY HETEROGENEOUS FRAME RATES FOR PICTURE-BY-PICTURE PRESENTATION

(71) Applicant: Dell Products L.P., Round Rock, TX (US)

(72) Inventors: Dengzhai Xiong, Singapore (SG); Vui Khen Thien, Singapore (SG); Ghee Beng Ooi, Singapore (SG)

(73) Assignee: Dell Products L.P., Round Rock, TX (US)

(21) Appl. No.: 19/086,323

(22) Filed: Mar. 21, 2025

(51) Int. Cl. H04N 7/01; H04N 5/45

(52) U.S. Cl. CPC H04N 7/013; H04N 5/45

(57) ABSTRACT

A display interfaced with plural information handling systems presents information as visual images in a picture-by-picture configuration that applies a frame rate of a primary source synchronized with a secondary source. The display scalar executes instructions stored in non-transitory memory to retrieve a frame rate request from each of the plural information handling systems and apply to the presentation of picture-by-picture visual images the frame right of a primary source. The frame rate request of the primary source is provided up to the display maximum frame rate, although a lower harmonious common frame rate may be set as a factor of another display having a lower frame rate.

### BACKGROUND OF THE INVENTION

### Field of the Invention

The present invention relates in general to the field of information handling system displays, and more particularly to an information handling system peripheral display heterogeneous frame rates for picture-by-picture presentation.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems process information with a processor and memory coupled in a housing. Stationary information handling system configurations, such as desktop and tower systems, interact with end users through peripheral devices, such as a peripheral display, peripheral keyboard and peripheral mouse. Portable information handling system configurations integrate processing components, a display and a power source in a portable housing to support mobile operations. Portable information handling systems allow end users to carry a system between meetings, during travel, and between home and office locations so that an end user has access to processing capabilities while mobile. Portable information handling systems also will typically support end user interactions through peripheral devices. As an example, an end user can interface a portable information handling system with two separate peripheral displays and interact through both the integrated and a peripheral keyboard.

This arrangement will support an end user presenting a wide variety of visual image types at the displays, such as movies, games, office applications and other types of visual images.

Information handling system displays present visual images under the management of a scalar integrated circuit that controls how visual images are scaled and then scanned as pixel values to a display panel by a timing controller. Such local management of visual image presentation helps to provide a flexible interaction between different types of displays, information handling systems and visual image content. In some instances, a display can support multiple information handling systems presenting visual images simultaneously. For example, a display receives each of plural information handling system visual information inputs as separate sources, such as each information handling system at a display cable port. An end user can select which source to use to present visual images or can present both sources simultaneously in a picture-by-picture configuration where each source is assigned to a block of display panel pixels. The scalar accepts end user inputs to divide the display panel between the different video sources and then the timing controller scans the combined visual image presentation for each of the video sources from a frame buffer to the display panel. One difficulty with this approach is that different types of visual images are scanned at different frames per second (fps). For instance, a gaming application might call for 120fps to present active gaming content while an office application might call for 20fps; however, displays typically scan visual images at the same rate for all content. Modern displays support very high scan rates and variable refresh rates (VRR), however, these higher scan rates tend to increase power use of the display and add little value to the end user experience when more basic types of content are presented at high scan rates.

### SUMMARY OF THE INVENTION

Therefore, a need has arisen for a system and method which presents visual images at a display panel from multiple video sources with managed frame rates.

In accordance with the present invention, a system and method are provided which substantially reduce the disadvantages and problems associated with previous methods and systems for presenting visual images at a display. A display scalar manages frame rate requests received from plural information handling systems to present visual images at a display panel scanned at a frame rate of a primary information handling system when the plural information handling systems are configured to present the visual images in a picture-by-picture configuration.

More specifically, plural information handling systems process information with a processor that executes instructions in cooperation with a memory that stores the instructions and information, and communicates the information to a shared display for presentation at the display in a picture-by-picture configuration. Information handling systems send a frame rate request to the display and receive an EDID declaration of the frame rate. Picture-by-picture windows from separate sources are managed as one primary source and one or more secondary sources to decide on a frame rate allocation. A frame rate manager executing on the display scalar sets the frame rate to the primary source request, and can set a lower frame rate where a harmonious common output is desired as a factor of a secondary source supported frame rate. In some instances where a secondary source has a greater frame rate than the primary source, the secondary source frame rate may be selected.

The present invention provides a number of important technical advantages. One example of an important technical advantage is that a display panel selectively presents visual images in a picture-by-picture mode from plural information handling system sources with coordination for setting a frame rate that will satisfy the plural sources and better manage display power consumption. The different frame rate settings applied for the different sources allow the display to present the visual images in a picture-by-picture mode without the source needing to adjust graphics output so that no disruption of video playback takes place.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a display configured to coordinate a frame rate of plural sources when presenting visual images in a picture-by-picture mode;

FIG. 2 depicts a block diagram of a scalar configured to coordinate a frame rate of plural sources when presenting visual images in a picture-by-picture mode;

FIG. 3 depicts a block diagram of three sources requesting frame rate associated with display panel presentation areas;

FIG. 4 depicts a flow diagram of a process for arbitration of picture-by-picture frame rate set up;

FIG. 5 depicts a table of an example embodiment of workflow and preferred frame rate configurations;

FIG. 6 depicts a table of an example embodiment of frame rate EDID declarations for denominators and non-denominators;

FIG. 7 depicts an example flow diagram of a process for managing frame rate requests;

FIG. 8 depicts a block diagram of a scalar frame rate manager to manage display frame rate configuration; and

FIG. 9 depicts a flow diagram of a process for frame rate arbitration between primary and secondary video sources.

### DETAILED DESCRIPTION

Plural information handling systems interface with a display having logic executed on a scalar to coordinate presentation of visual images with frame rates in a picture-by-picture configuration. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

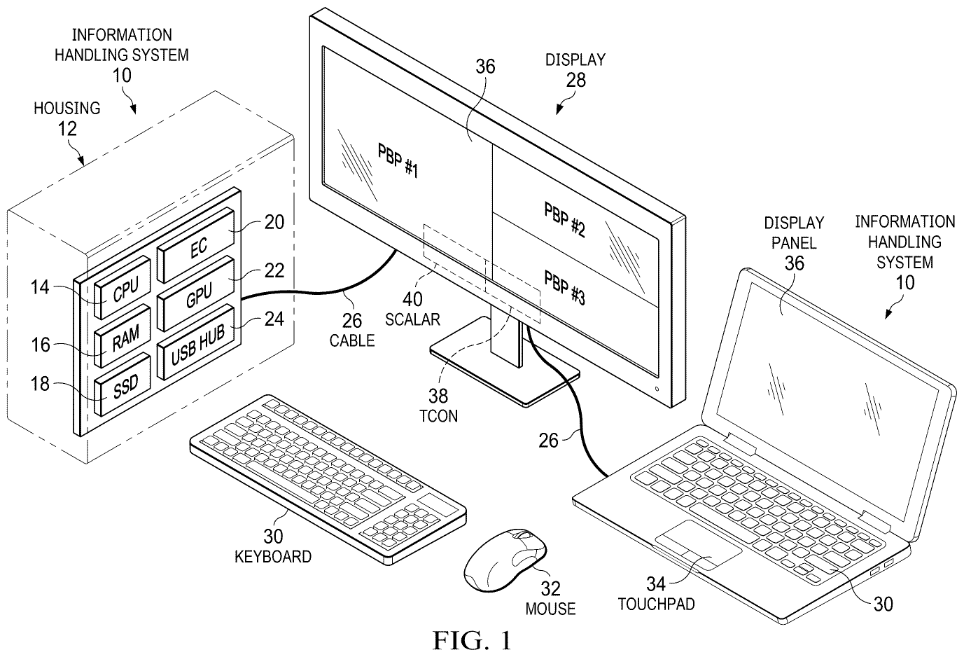

Referring now to FIG. 1, a block diagram depicts plural information handling systems 10 having a display 28 configured to coordinate a frame rate of plural sources when presenting visual images in a picture-by-picture mode. A desktop information handling system 10 is built in a stationary housing 12 that interfaces with peripheral devices to interact with an end user, such as display 28, peripheral keyboard 30 and peripheral mouse 32. A portable information handling system 10 has a portable housing that integrates a keyboard 30, touchpad 34 and display panel 36 to interact with an end user. Portable information handling system 10 also interacts through peripheral devices, such as display 28, peripheral keyboard 30 and mouse 32. Desktop information handling system 10 depicts examples of processing components that are included in housing 12 to process information. A central processing unit (CPU) 14 executes instructions to process information in cooperation with a random access memory (RAM) 16 that stores the instructions and information. A solid state drive (SSD) 18 provides non-transient storage of instructions and information during system power down, such as an operating system and applications that are retrieved to RAM 16 at system power up.

A graphics processing unit (GPU) 22 further processes information to present at a display panel 36, such as by defining pixel values that set colors for pixels to generate visual images. An embedded controller 20 executes firmware to manage component interactions, such as application of power and management of thermal constraints.

Embedded controller 20 also manages interactions with external devices, such as keyboards and mice. A USB hub 24 supports communication through USB cables, such as a display cable 26 that communicates visual images to display 28. The processing components depicted in the example embodiment of desktop information handling system 10 may also be found in the example embodiment of portable information handling system 10.

In the example embodiment, GPU 22 of each information handling system generates visual images for presentation at display 28 with three picture-by-picture areas PBP #1, PBP #2 and PBP #3 presented on display panel 36 simultaneously. Display 28 interfaces through display cables 26 as a peripheral display device for three information handling system video sources (the third video source is not shown) and presents visual images at display panel 36 with an array of pixels that receive pixel values from a timing controller 38 to set a color, such as by applying an electric field to a liquid crystal material that filters light passing through the display panel from a backlight. Scalar 40 is an integrated circuit and/or chipset that receives visual information from GPUs 22 and scales the visual images for presentation at the resolution of the array of pixels as defined by the picture-by-picture configuration.

Scalar 40 manages frame rate requests from each of the plural information handling systems to present all of the picture-by-picture visual images with a common frame rate that satisfies the end user's viewing goals and does not require any disruption of the source video at each information handling system. As an example, PBP #1 may be used for gaming while the other PBP display panel areas present document editing or similar functions. An end user selects a source video as a primary source and each PBP display area is offered a frame rate preference by an Extended Display Identification Data (EDID) declaration to the source information handling system. The scalar first determines a frame rate for a primary video source and then ensures that the primary frame rate is compatible with the frame rate requested by the secondary video sources. In one embodiment, the primary picture-by-picture source is selected by an end user through a user interface. Alternatively, the primary video source may be selected by default when an end user selection is not made, such as by assigning the largest display picture-by-picture area as the primary, or the request that has the highest frame rate. In some instances, the primary video source is not compatible with a secondary video source so that the primary video source is adjusted up or down to be a factor of the secondary video source so that the video sources have a harmonious common output frame rate. The scalar video pipes are then configured to synchronize the input frame rates with the display panel presentation frame rate. Since the necessary frame rate conversion is enabled through the video pipes, the video sources need not set up the graphics output but rather simply output the frame rate requested and approved by the scalar. This allows presentation of the plural video sources at the display without disruption of video playback due to different frame rate requests.

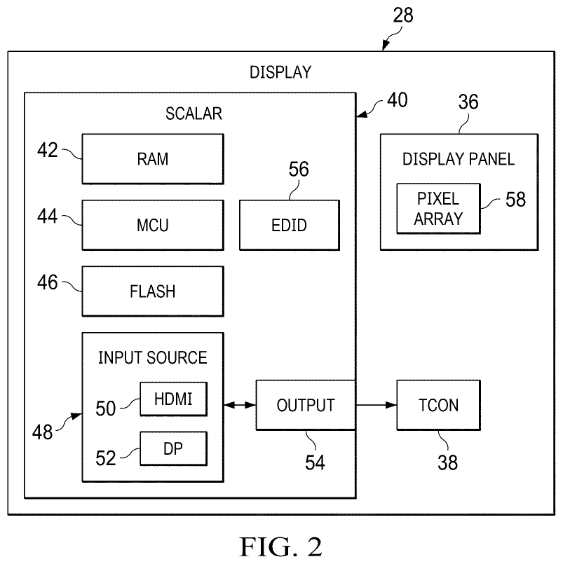

Referring now to FIG. 2, a block diagram depicts a scalar 40 configured to coordinate a frame rate of plural sources when presenting visual images in a picture-by-picture mode. Scalar 40 accepts visual images from an input source 48, such as HDMI 50, DP 52 or other video source protocols, and outputs the visual images as a video output 54, such as a 16 lane eDP output to a timing controller 38 that scans the visual images as pixel values to a pixel array 58 of a display panel 36. Scalar 40 includes RAM 42 that stores visual image information, such as with a frame buffer, so that an MCU 44 or similar processing resource can scale the visual image to a desired resolution, such as to present the visual images in a picture-by-picture area of display panel 36. A flash memory 46 or other non-transient memory stores instructions that execute on MCU 44 to coordinate frame rates for picture-by-picture presentation of visual images. An EDID memory stores EDID values and display configuration settings. For example, EDID 56 may store a frame rate range available to video sources for both single video source presentation and picture-by-picture multiple video source presentation.

In operation, when plural video sources are configured to present visual images in a picture-by-picture mode, display panel 36 has a maximum frame rate available in EDID to respond to frame rate requests of the video sources. The primary video source request is the request used to decide the display panel frame rate so that, if the primary video source requests the maximum frame rate or greater then the maximum frame rate is selected. Once the primary video source frame rate is selected, the secondary video source frame rates are declared to be within the primary frame rate. The secondary frame rate is decided by an arbitration algorithm based upon its source request. The secondary frame rate is selected to be compatible with the primary frame rate and, where additional video sources are involved, with the additional video sources. When the secondary frame rate is compatible with the primary frame rate, the scalar approves the requested frame rate with an EDID declaration and buffers the frame information to match the primary frame rate for the presentation of the visual information. When the secondary frame rate is not compatible, the scalar can adjust either the primary frame rate or the secondary frame so that frames from the video sources can be synchronized by the video pipe, such as by buffering frames between secondary source communications of video information. In one example embodiment, the primary video source frame rate is increased or decreased to establish a frame rate which is a common multiplier of all secondary video sources. Note that decreasing source frame rates helps to reduce power consumption and may be preferred in some situations. When all video sources find a common frame rate that is lower than the maximum display panel frame rate and meet the requirements of the respective visual information presentation, an optimal frame rate is available to achieve power savings. The secondary video sources who have set up their EDID declarations will not be affected by the frame rate. Frame rate arbitration affects the display panel configuration by selecting the compatible frame rate and possibly triggering a video pipe frame rate reconfiguration, but no setup of the input source is needed to present the visual information.

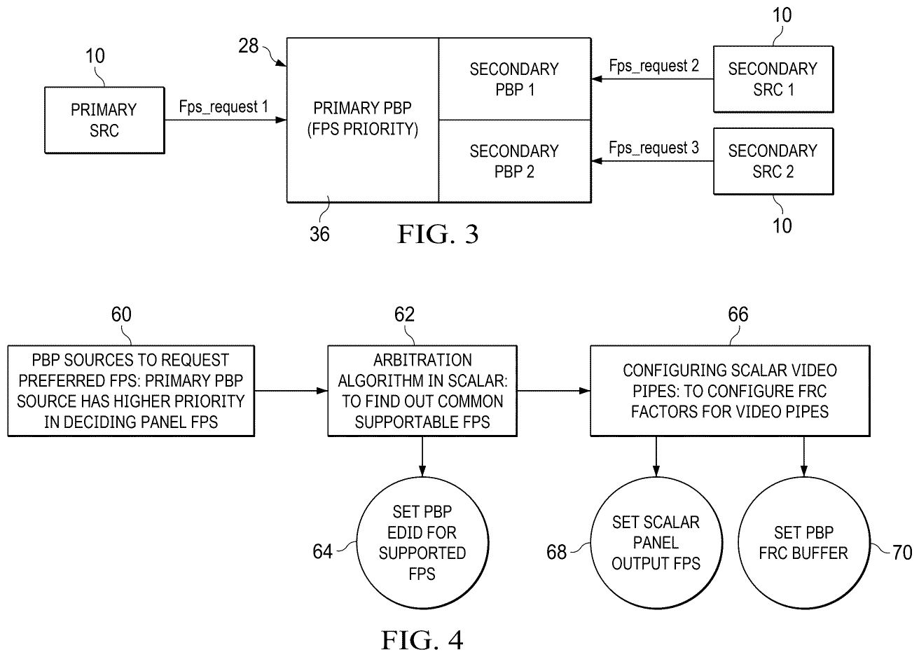

Referring now to FIG. 3, a block diagram depicts three sources requesting a frame rate associated with display panel presentation areas. A primary source information handling system 10 is designated by an end user and sends a frame rate request to the display panel 36 for a primary picture-by-picture area. The scalar of the display panel responds with an EDID declaration of the available frame rate up to a maximum frame rate supported by the display panel. When the display panel supports variable refresh rate (VRR) presentation, the frame rate may be any value between the maximum and minimum frame rates supported by the display panel. When the display panel does not support VRR, the frame rate may be limited to a factor of available frame rates, and may be provided as denominator frame rates or non-denominator frame rates.

Secondary information handling systems 10 labeled secondary source 1 and 2 each send a frame rate request to display panel 36. In the example embodiment, when the frame rate is compatible with the primary source frame rate, the scalar replies with an EDID declaration. When the frame rate is not compatible, the primary frame rate may be adjusted to allow an EDID declaration that meets the secondary source frame rate request. Alternatively, a lower or higher frame rate response may be sent by the display panel.

Referring now to FIG. 4, a flow diagram depicts a process for arbitration of picture-by-picture frame rate set up. The process starts at step 60 with the picture-by-picture sources sending a frame request to the display panel with a preferred frame rate. When the frame rate requests are received, the primary frame rate has priority in the decision by the scalar of the frame rate to apply at the display panel. The process continues to step 62 to arbitrate the frame rate requests with logic executing on the scalar to find a harmonious common output frame rate. At step 64 the EDID is set to the supported frame rate for each of the sources. At step 66 the scalar video pipe is configured to the frame rate factors for supporting presentation of the video at each of the picture-by-picture display panel areas. At step 68 the scalar sets the display panel for a selected output frame rate. At step 70 the scalar sets up the frame buffer to store video to support the frame rate for each source. For instance, a 60 frame per second primary frame rate and a 20 frames per second frame rate would store the frame of the secondary source for three cycles to each one of the primary source.

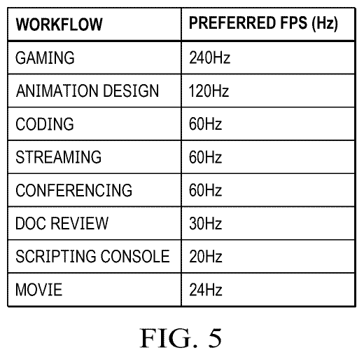

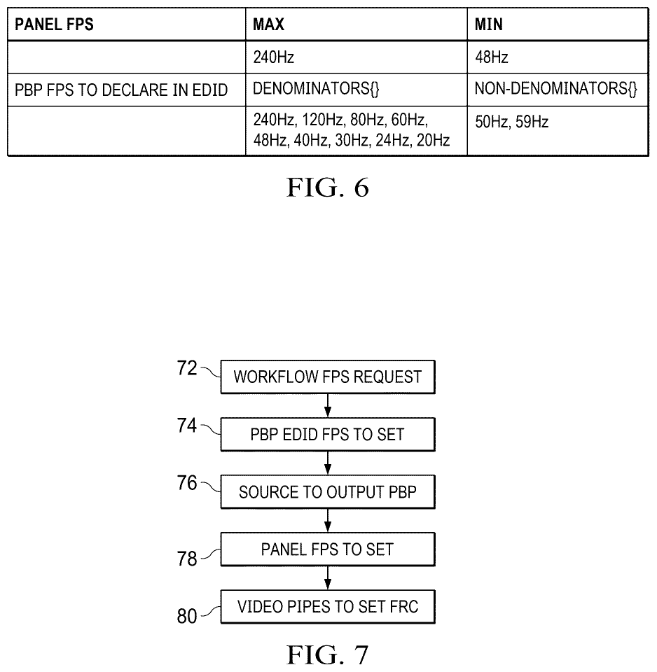

Referring now to FIG. 5, a table depicts an example embodiment of workflow and preferred frame rate configurations. In the example embodiment, an end user interfaces with the table to configure a preferred frame rate for each different types of workflows. At initiation of the presentation of picture-by-picture presentations, the video sources request the display panel to provide the preferred frame rate for each type of workflow. For example, a graphics drive of the operating system or an application presenting visual images requests the frame rate. FIG. 6 depicts a table of an example embodiment of frame rate EDID declarations for denominators and non-denominators of frame rate requests to the display panel. The scalar frame rate manager decides the frame rate from the available options and programs the EDID to send a declaration of the rate as described above. The frame rate arbitration algorithm is applied by the scalar frame rate manager to find a compatible frame rate for all of the video sources.

Referring now to FIG. 7, an example flow diagram depicts a process for managing frame rate requests. The process starts at step 72 with a workflow frame rate request, such as based upon the table of FIG. 5. At step 74 the picture-by-picture EDID frame rate is set for the source. At step 76, the video source outputs the picture-by-picture visual image information to the display. At step 78 the display panel frame rate is set based upon the arbitrated frame rate. At step 80 the video pipes of the scalar are set to the frame rate as described above so that each picture-by-picture source sends the visual image information at the frame rate for the workflow as identified by FIG. 5.

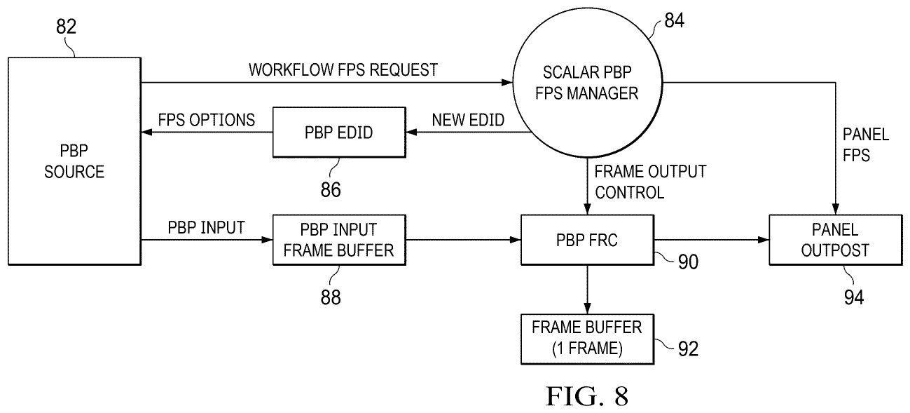

Referring now to FIG. 8, a block diagram depicts a scalar frame rate manager 84 to manage display frame rate configuration. A workflow request is communicated from the picture-by-picture video source 82 to the scalar frame rate manager 84, which communicates a picture-by-picture EDID declaration 86 back to video source 82 and communicates the frame rate to the display panel 94. EDID declaration 86 to the video source 82 confirms that the video can be initiated to the input frame buffer 88. Frame rate manager 84 provides a frame output control to a frame rate controller 90, which applies the video source visual information from frame buffer 92 to present the visual images at display panel 94 with the frame buffer scanned by the video pipe of the frame rate controller each frame rate period.

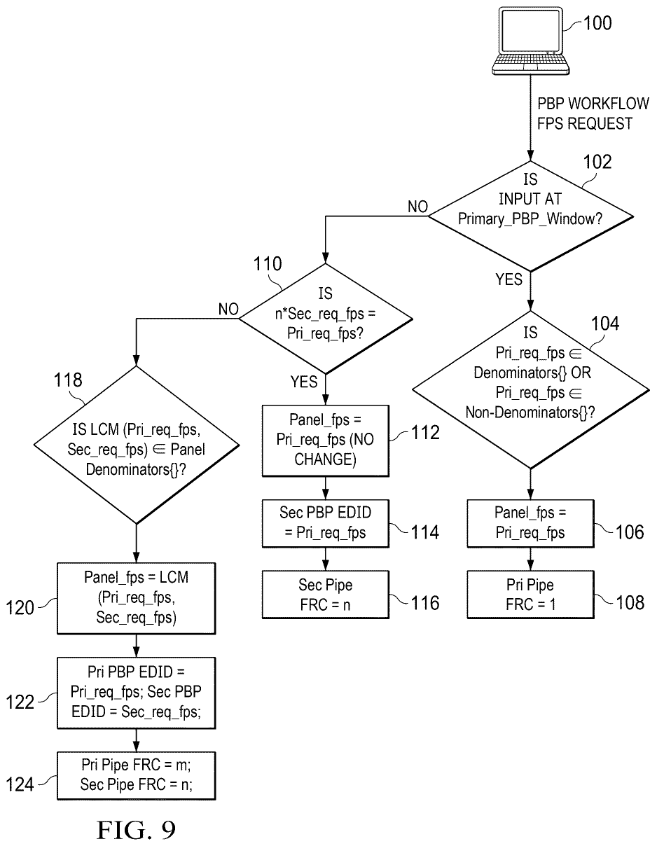

Referring now to FIG. 9, a flow diagram depicts a process for frame rate arbitration between primary and secondary video sources. The process starts with a video source 100 that communicates a workflow request. At step 102 a determination is made of whether the request is from a primary video source. If the request is from the primary video source, the process continues to step 104 to determine if the requested frame has denominators. At step 106 the display panel frame rate is set to the primary source request value up to the maximum frame rate value. At step 108 the primary video source video pipe is activated to communicate the video information at the requested frame rate. If at step 102 the video source is a secondary video source, the process continues to step 110 to determine if the secondary video source frame rate request times an integer value is equal to the primary video source frame rate, i.e., so that the frames buffer from the secondary source at an interval of the primary source. If so the process continues to step 112 to keep the frame rate the same value, to step 114 to set the secondary video source frame rate to the same value as the primary video source frame rate by an EDID declaration and at step 116 the secondary video source visual image communication is initiated. If the primary and secondary video source frame rates are not equal, the process continues to step 118 to determine if the lower frame rate is a least common multiplier so that a denominator exists. For instances, for integers m and n, m times the primary requested frame rate equals n times the secondary requested frame rate. If no denominator exists, the process can reset to initiate a primary frame rate with a denominator. If a denominator exists, the process continues to step 120 to set the frame rate to the denominator frame rate. The frame rate is set at step 122 for the secondary and the primary video sources and at step 124 the video pipe initiates communication of the video information from both video sources.

Although the present invention has been described in detail, it should be understood that various changes, substitutions and alterations can be made hereto without departing from the spirit and scope of the invention as defined by the appended claims.

1. A system comprising:
a first information handling system having a first housing, a first processor and a first memory, the first processor and first memory cooperating to process information;
a second information handling system having a second housing, a second processor and a second memory, the second processor and second memory cooperating to process information;
a display interfaced with the first information handling system and the second information handling system, the display having a display panel with an array of pixels that define visual images, a timing controller interfaced with the display panel that scans pixel values to the array of pixels, and a scalar interfaced with the timing controller, the scalar including a processing resource; and
a non-transitory memory interfaced with the scalar and storing instructions that when executed on the scalar cause:
designation of the first information handling system as a primary frame rate source;
retrieval of a first frame rate request from the first information handling system;
retrieval of a second frame rate request from the second information handling system;
a first Extended Display Identification Data (EDID) declaration to the first information handling system and the second information handling system having a non-picture-by-picture frame rate; and
a second EDID declaration to the first information handling system and the second information handling system having a picture-by-picture frame rate; and
presentation of visual images from both the first and second information handling systems when in a picture-by-picture mode based upon the first frame rate request.

2. The system of claim 1 further comprising instructions stored in the non-transient memory that when executed on the scalar cause:
comparison of the first frame rate request against a maximum frame rate of the display panel;
assigning the maximum frame rate of the display panel when the first frame rate request is greater than or equal to the maximum frame rate of the display panel; and
assigning the first frame rate request when the first frame rate request is less than the maximum frame rate of the display panel.

3. The system of claim 2 further comprising instructions stored in the non-transient memory that when executed on the scalar cause:
receipt of visual information from the first information handling system at the assigned frame rate; and
synchronization of visual information received from the second information handling system to the assigned frame rate by the scalar.

4. The system of claim 3 wherein the second information handling system communicates the visual information without disruption.

5. (canceled)

6. The system of claim 1 further comprising instructions stored in the non-transient memory that when executed on the scalar cause automatically designating the primary frame rate source based upon the size of the display panel assigned to each picture-by-picture presentation area.

7. The system of claim 1 further comprising instructions stored in the non-transient memory that when executed on the scalar cause automatically designating the primary frame rate source based upon the frame rate request amount received from the first information handling system and the second information handling system.

8. The system of claim 1 further comprising instructions stored in the non-transient memory that when executed on the scalar cause:
presentation at the display panel of a user interface to select a visual image source as a primary source for picture-by-picture visual image presentation; and
receipt of an end user selection of the first information handling system as the primary source.

9. The system of claim 1 further comprising instructions stored in the non-transient memory that when executed on the scalar cause:
comparison of the first frame rate and the second frame rate to determine a harmonious common frame rate of less than the first frame rate; and
presentation of visual images from both the first and second information handling systems when in a picture-by-picture mode based upon the harmonious common frame rate.

10. A method for presenting visual images at a display, the method comprising:
designating one of plural information handling systems as a primary frame rate source;
retrieving of a first frame rate request from the one of plural information handling systems;
retrieving of a second frame rate request from another of the plural information handling system;
comparing the first frame rate and the second frame rate to determine a harmonious common frame rate of less than the first frame rate;
receiving visual information from the one of the plural information handling systems at the harmonious common frame rate; and
synchronizing visual information received from another of the plural information handling systems to the harmonious common frame rate by the scalar; and
presenting of visual images from the plural information handling systems when in a picture-by-picture mode based upon the first frame rate request.

11. The method of claim 10 further comprising:
comparing the first frame rate request against a maximum frame rate of the display panel;
assigning the maximum frame rate of the display panel when the first frame rate request is greater than or equal to the maximum frame rate of the display panel; and
assigning the first frame rate request when the first frame rate request is less than the maximum frame rate of the display panel.

12. (canceled)

13. (canceled)

14. The method of claim 10 further comprising:
declaring a first Extended Display Identification Data (EDID) to the plural information handling systems having a non-picture-by-picture frame rate; and
declaring a second EDID to the plural information handling systems having a picture-by-picture frame rate.

15. The method of claim 14 further comprising presenting at the display a user interface to select a visual image source as a primary source for picture-by-picture visual image presentation; and
receiving an end user selection of the one of the plural information handling systems as the primary source.

16. A display comprising:
a display panel with an array of pixels that present visual images;
a timing controller interfaced with the display panel that scans pixel values to the array of pixels;
a scalar interfaced with the timing controller and having a processing resource to manage display panel operations; and
a non-transitory memory interfaced with the scalar and storing instructions that when executed on the processing resource cause:
designation of a first information handling system as a primary frame rate source;
retrieval of a first frame rate request from the first information handling system;
retrieval of a second frame rate request from a second information handling system;
receipt of visual information from the first information handling system at the assigned frame rate;
synchronization of visual information received from the second information handling system to the assigned frame rate by the scalar; and
presentation of visual images from both the first and second information handling systems when in a picture-by-picture mode based upon the first frame rate request.

17. The display of claim 16 further comprising instructions stored in the non-transient memory that when executed on the processing resource cause:
comparison of the first frame rate and the second frame rate to determine a harmonious common frame rate of less than the first frame rate; and
presentation of visual images from both the first and second information handling systems when in a picture-by-picture mode based upon the harmonious common frame rate.

18. (canceled)

19. The display of claim 16 further comprising instructions stored in the non-transient memory that when executed on the processing resource causes:
comparison of the first frame rate request against a maximum frame rate of the display panel;
assigning the maximum frame rate of the display panel when the first frame rate request is greater than or equal to the maximum frame rate of the display panel; and
assigning the first frame rate request when the first frame rate request is less than the maximum frame rate of the display panel.

20. The display of claim 19 further comprising instructions stored in the non-transient memory that when executed on the processing resource causes:
a first Extended Display Identification Data (EDID) declaration to the first information handling system and the second information handling system having a non-picture-by-picture frame rate; and
a second EDID declaration to the first information handling system and the second information handling system having a picture-by-picture frame rate.
